(19) United States
(12) Patent Application Publication
(10) Pub. No.: US 2025/0224480 A1
(43) Pub. Date: Jul. 10, 2025

(54) GEODETIC FRAME KALMAN FILTER FOR TARGET GEOLOCATION AND TRACKING

(71) Applicant: BAE Systems Information and Electronic Systems Integration Inc., Nashua, NH (US)

(72) Inventor: Dean C. Slocum, Nashua, NH (US)

(73) Assignee: BAE Systems Information and Electronic Systems Integration Inc., Nashua, NH (US)

(21) Appl. No.: 17/497,404

(22) Filed: Oct. 8, 2021

(51) Int. Cl. G01S 5/02

(52) U.S. Cl. CPC G01S 5/0294

(57) ABSTRACT

Techniques are provided for geolocation and tracking of a target emitter. A methodology implementing the techniques according to an embodiment includes receiving measurement data associated with a signal from an emitter, and receiving an estimated uncertainty associated with the measurement data. The measurement data may be provided, for example, by a radar receiver. The method further includes employing a Kalman filter to calculate a geolocation of the emitter, based on the measurement data and the estimated uncertainty. The calculation includes constraining the geolocation of the emitter to the surface of the Earth, for example in a geodetic coordinate system. The measurement data may include azimuth angle of arrival of the signal and depression angle of arrival of the signal or a time difference of arrival of the signal between two measurement platforms. The methodology may be carried out, for instance, onboard an aircraft, projectile, or missile.

### FIELD OF DISCLOSURE

The present disclosure relates to geolocation, and more particularly, to use of a geodetic frame Kalman filter for geolocation and tracking of a target emitter.

### BACKGROUND

It is often necessary to locate and track a target of interest based on signals emitted from that target. Existing systems can perform location and tracking of target emitters with varying degrees of accuracy. These systems, however, typically employ computationally intensive algorithms. Such systems require computational resources which may not be practical or feasible for many applications where cost, size, weight, and power restrictions are a concern.

### BRIEF DESCRIPTION OF THE DRAWINGS

FIG. 1 illustrates an airborne platform employed in an example emitter geolocation and tracking scenario, in accordance with an embodiment of the present disclosure.

FIG. 2 is a block diagram of an emitter tracking system, configured in accordance with an embodiment of the present disclosure.

FIG. 3 is a block diagram of the geodetic frame Kalman filter of FIG. 2, configured in accordance with an embodiment of the present disclosure.

FIG. 4 is a block diagram of the estimation processor of FIG. 3, configured in accordance with an embodiment of the present disclosure.

FIG. 5 is a flowchart illustrating a methodology for emitter geolocation and tracking using the geodetic frame Kalman filter of FIG. 3, in accordance with an embodiment of the present disclosure.

FIG. 6 is a block diagram schematically illustrating a processing platform employing an emitter tracking system, in accordance with certain embodiments of the present disclosure.

Although the following Detailed Description will proceed with reference being made to illustrative embodiments, many alternatives, modifications, and variations thereof will be apparent to those skilled in the art.

### DETAILED DESCRIPTION

Techniques are provided for geolocation and tracking of a target of interest (e.g., a target emitter) using a geodetic frame Kalman filter. As noted previously, existing tracking systems typically employ computationally intensive algorithms that require resources which may not be available for applications where cost, size, weight, and power restrictions are of particular concern. The disclosed techniques can be used to provide relatively high location and tracking accuracy with improved computational efficiency, relative to existing solutions, according to some embodiments. To this end, and in accordance with an embodiment of the present disclosure, a geolocation and tracking system is disclosed which constrains the location of the target emitter to the surface of the Earth to simplify calculations. This constraint is appropriate in many applications where the emitter is known to be ground based, whether it is stationary or moving.

The disclosed techniques can be implemented, for example, in a computing system or a software product executable or otherwise controllable by such systems, although other embodiments will be apparent (e.g., gate-level logic). In accordance with an embodiment, a methodology to implement these techniques includes receiving measurement data associated with a signal from an emitter. The method also includes receiving an estimated uncertainty associated with the measurement data. The measurement data may be provided by a radar receiver. The method further includes employing a Kalman filter to calculate a geolocation of the emitter, based on the measurement data and the estimated uncertainty. In some embodiments, the measurement data may be referenced to a geodetic coordinate system. The calculation is simplified by constraining the geolocation of the emitter to the surface of the Earth which reduces the number of filter states that need to be maintained and updated. The measurement data may include azimuth angle of arrival of the signal and depression angle of arrival of the signal or a time difference of arrival of the signal between two measurement platforms. In some embodiments, the Kalman filter may be a two state filter, a four state filter, or a six state filter, depending on whether the emitter is constrained to a fixed location, fixed velocity, or fixed acceleration, respectively.

It will be appreciated that the geolocation and tracking techniques described herein may provide improved performance, compared to existing techniques that use computationally expensive tracking filters to handle target locations that are unconstrained over a 3-dimensional volume of space. The techniques disclosed herein may further be implemented in hardware or software or a combination thereof. Numerous embodiments and applications will be apparent in light of this disclosure.

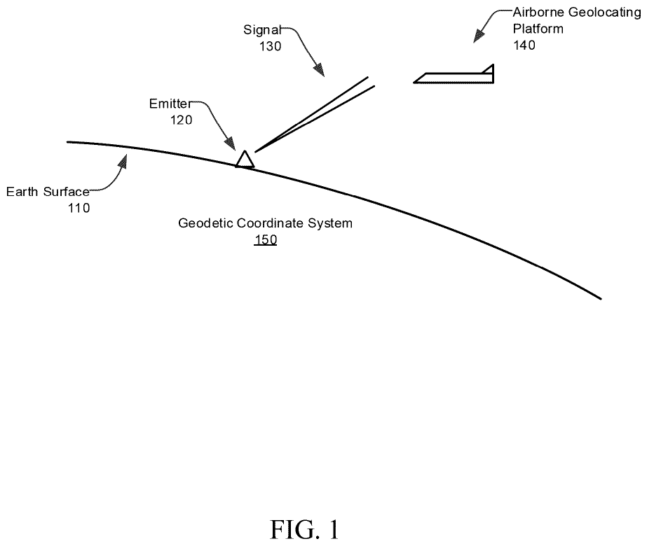

FIG. 1 illustrates an airborne platform 140 employed in an example emitter geolocation and tracking scenario 100, in accordance with an embodiment of the present disclosure. The airborne platform is configured to perform geolocation and tracking of a target emitter of interest 120 that is ground based. In some embodiments, the airborne platform may be an aircraft (fixed wing or helicopter), a projectile or missile, or any other suitable platform. The emitter emits a signal 130, such as, for example, an RF or radar signal, that can be detected by the airborne platform 140. The target emitter of interest 120 is ground based, which is to say that the emitter location is constrained to the surface of the Earth 110. In some embodiments, the surface may be augmented with digital terrain data so that it is not required to assume that the surface is a smooth sphere. In some embodiments, the emitter 120 can be stationary, moving at a constant velocity, or accelerating. Tracking of the emitter 120 is performed in a geodetic coordinate system 150, such as, for example a World Geodetic Coordinate system (WGS-84).

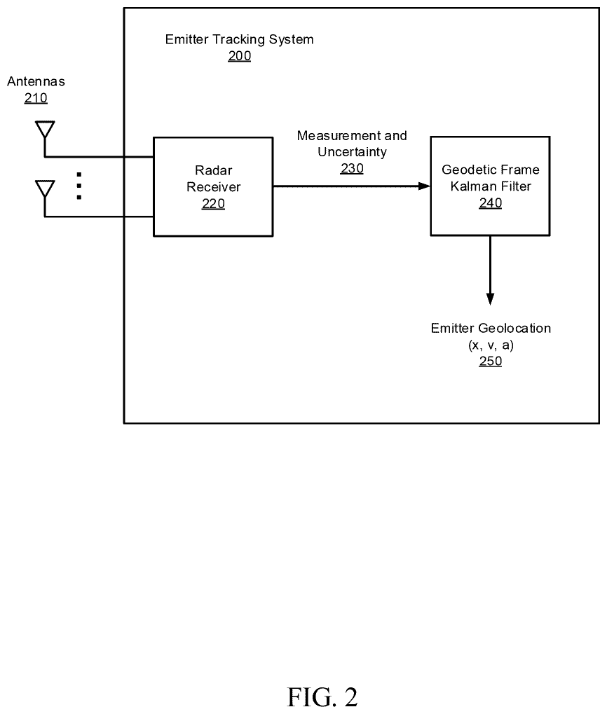

FIG. 2 is a block diagram of an emitter tracking system 200, configured in accordance with an embodiment of the present disclosure. The emitter tracking system 200 is shown to include antenna(s) 210, a radar receiver 220, and a geodetic frame Kalman filter 240.

The antenna or antennas 210 are configured to receive a signal 130 that is transmitted (or reflected) from the ground based emitter of interest 120 (e.g., a target emitter).

The radar receiver 220 is configured to provide measurement data (and associated uncertainty) 230 based on the received signal. In some embodiments, the measurement data includes information regarding the angle of arrival (AOA) of the signal at the platform. The AOA may include two components: an azimuth angle and a depression angle. In some embodiments, the measurement data includes information regarding the time difference of arrival (TDOA) of the signal between two or more antennas (of the same platform or different platforms).

The geodetic frame Kalman filter 240 is configured to calculate and update a geolocation 250 of the emitter at each time iteration k, based on newly provided measurement data and estimated uncertainty, as will be described in greater detail below. In some embodiments, the measurement data may be referenced to a geodetic coordinate system. In some embodiments, the geolocation 250 provided by the filter 240 also includes velocity and acceleration.

The Kalman filter geolocation algorithm is a Kalman-based approach for estimating the location of an emitter in a WGS-84 geodetic coordinate system. The filter can be implemented using any number of Kalman filter “flavors” (e.g., an Unscented Kalman Filter, an Iterated Sigma Point Kalman Filter, or an Extended Kalman Filter) that are capable of estimating non-linear relationships between the measurement and current filter state. The Unscented Kalman Filter (UKF) implementation, as described herein, provides advantages relative to the other flavors, including a simplified approximation of nonlinear functions relating measurements to state likelihood, a “third-order” approximation of true mean and covariance, and reduced computational complexity. Additionally, the constraining assumption that the emitter is located on the surface of the Earth allows the estimation process to operate relative to the two-dimensional surface of the Earth's spheroid (potentially augmented with digital terrain data) to further reduce computational complexity.

The measurement data provided to the geodetic frame Kalman filter 240 can be expressed as a vector zₖ and the measurement uncertainty can be expressed as a covariance matrix Rₖ at each time iteration k, for each of the measurement modalities, either AOA or TDOA.

More specifically, the measurement vector and corresponding measurement covariance for the k^{th} time iteration for the AOA modality are given as:

$${z}_{k} = {[ \begin{matrix}{az}_{meas} & {dep}_{meas}\end{matrix} ]}_{k} \\ {R}_{k} = {[ \begin{matrix}{σ}_{{az}_{meas}}^{2} & 0 \\ 0 & {σ}_{{dep}_{meas}}^{2}\end{matrix} ]}_{k}$$

where: zₖ=filter measurement vector
   Rₖ=filter measurement covariance matrix
   azₘₑₐₛ=azimuth angle of arrival measurement
   depₘₑₐₛ=depression angle of arrival measurement
   σ_{az}_{ₘₑₐₛ}=azimuth angle of arrival measurement uncertainty (1-sigma)
   σ_{dep}_{ₘₑₐₛ}=depression angle of arrival measurement uncertainty (1-sigma)

The measurement vector and corresponding measurement covariance for the k^{th} time iteration for the TDOA modality are given as:

$${z}_{k} = {[ \begin{matrix}{tdoa}_{{meas}_{1 , 2}} & {tdoa}_{{meas}_{i , j}} & {tdoa}_{{meas}_{N - 1 , N}}\end{matrix} ]}_{k} \\ {R}_{k} = {[ \begin{matrix}{σ}_{{tdoa}_{{meas}_{1 , 2}}}^{2} & 0 & 0 \\ 0 & {σ}_{{tdoa}_{{meas}_{i , j}}}^{2} & 0 \\ 0 & 0 & {σ}_{{tdoa}_{{meas}_{N - 1 , N}}}^{2}\end{matrix} ]}_{k} \\ where : \\ {tdoa}_{{meas}_{i , j}} = {toa}_{{meas}_{i}} - {toa}_{{meas}_{j}} \\ {σ}_{{tdoa}_{{meas}_{i , j}}} = \sqrt{{σ}_{{toa}_{{meas}_{i}}}^{2} + {σ}_{{toa}_{{meas}_{j}}}^{2}}$$

and: zₖ=filter measurement vector
   Rₖ=filter measurement covariance matrix
   N=number of time measurement platforms

$${toa}_{{meas}_{i}}$$

=time of arrival measurement from platform “i”

$${σ}_{{toa}_{{meas}_{i}}}$$

i=“first” platform index (i=1, 2, . . . , N−1)
j=“second” platform index (j=i+1, i+2, . . . , N)

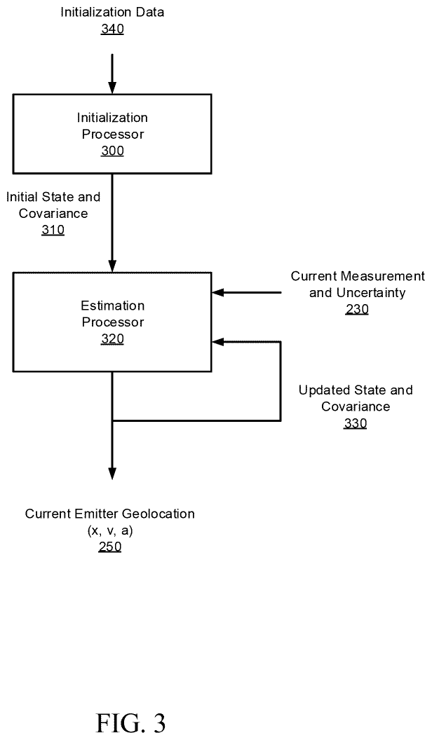

FIG. 3 is a block diagram of the geodetic frame Kalman filter 240 of FIG. 2, configured in accordance with an embodiment of the present disclosure. The geodetic frame Kalman filter 240 is shown to include an initialization processor 300 and an estimation processor 320.

The initialization processor 300 is configured to obtain initialization data 340 and provide initial position and uncertainty information to the estimation processor 320 in the form of an initial Kalman filter state vector and covariance matrix 310. The Kalman filter state vector and covariance matrix will be described in greater detail below. In some embodiments, the initialization data 340 may be determined from mission parameters, for example, some region of interest is known a-priori and the region is bounded with an uncertainty estimate. In some embodiments, the initialization data 340 may be obtained from the radar receiver 220 or from any other suitable source.

The estimation processor 320 is configured to generate an updated filter state and covariance 330, at each time iteration, based on the previous (or initial) state and covariance and newly provided current measurements and corresponding uncertainty 230. The estimation processor 320 is also configured to compute consistent estimates of the emitter location 250 (and velocity/acceleration for moving emitters) relative to its associated covariance at each time iteration, as will be described in greater detail below.

The Kalman filter can operate with 2, 4 or 6 states depending on the expected kinematics of the target emitter of interest. For example, when an emitter of interest is expected to be stationary, the filter only needs to estimate the emitter's planar position. As a result, in this 2-state operational mode, the filter state vector and covariance matrix for the k^{th} time iteration are defined as follows:

$${\hat{x}}_{k , k} = {[ \begin{matrix} & \end{matrix} ]}_{k} \\ {P}_{k , k} = {[ \begin{matrix}{σ}_{lat}^{2} & {σ}_{lat} {σ}_{lon} \\ {σ}_{lat} {σ}_{lon} & {σ}_{lon}^{2}\end{matrix} ]}_{k}$$

where: \hat{x}_{k,k}=filter state vector
   P_{k,k}=filter state covariance matrix
   [symbol] =filter estimated emitter latitude
   [symbol] =filter estimated emitter longitude
   σₗₐₜ=filter estimated emitter latitude uncertainty (1-sigma)
   σₗₒₙ=filter estimated emitter longitude uncertainty (1-sigma)

The notation used for state and covariance (i.e., x_{k,k}, P_{k,k}) indicate the propagation time iteration and the update time iteration relative to a given time iteration, respectively.

When an emitter of interest is expected to move with constant velocity motion, the filter augments the planar position-only estimation with planar velocity estimation in order to adequately describe the kinematic motion of the emitter. As a result, in this 4-state operational mode, the filter state vector and covariance matrix are defined for the k^{th} time iteration as follows:

$${\hat{x}}_{k , k} = {[ \begin{matrix} & & {north}_{} & {east}_{}\end{matrix} ]}_{k} \\ {P}_{k , k} = {[ \begin{matrix}{σ}_{lat}^{2} & {σ}_{lat} {σ}_{lon} & {σ}_{lat} {σ}_{{vel}_{north}} & {σ}_{lat} {σ}_{{vel}_{east}} \\ {σ}_{lat} {σ}_{lon} & {σ}_{lon}^{2} & {σ}_{lon} {σ}_{{vel}_{north}} & {σ}_{lon} {σ}_{{vel}_{east}} \\ {σ}_{lat} {σ}_{{vel}_{north}} & {σ}_{lon} {σ}_{{vel}_{north}} & {σ}_{{vel}_{north}}^{2} & {σ}_{{vel}_{north}} {σ}_{{vel}_{east}} \\ {σ}_{lat} {σ}_{{vel}_{east}} & {σ}_{lon} {σ}_{{vel}_{east}} & {σ}_{{vel}_{north}} {σ}_{{vel}_{east}} & {σ}_{{vel}_{east}}^{2}\end{matrix} ]}_{k}$$

where: \hat{x}_{k,k}=filter state vector
   P_{k,k}=filter state covariance matrix
   [symbol] =filter estimated emitter latitude
   [symbol] =filter estimated emitter longitude
   [symbol] ₙₒᵣₜₕ=filter estimated emitter northing velocity
   [symbol] ₑₐₛₜ=filter estimated emitter easting velocity
   σₗₐₜ=filter estimated emitter latitude uncertainty (1-sigma)
   σₗₒₙ=filter estimated emitter longitude uncertainty (1-sigma)
   σᵥₑₗ_{ₙₒᵣₜₕ}=filter estimated emitter northing velocity uncertainty (1-sigma)
   σᵥₑₗ_{ₑₐₛₜ}=filter estimated emitter easting velocity uncertainty (1-sigma)

When an emitter of interest is expected to move with constant acceleration motion, the filter further augments the planar position and velocity estimation with planar acceleration estimation in order to adequately describe the kinematic motion of the emitter. As a result, in this 6-state operational mode, the filter state vector and covariance matrix are defined for the k^{th} time iteration as follows:

$${\hat{x}}_{k , k} = {[ \begin{matrix} & & {north}_{} & {east}_{} & {north}_{} & {east}_{}\end{matrix} ]}_{k} \\ {P}_{k , k} = {[ \begin{matrix}{σ}_{lat}^{2} & {σ}_{lat} {σ}_{lon} & {σ}_{lat} {σ}_{{vel}_{north}} & {σ}_{lat} {σ}_{{vel}_{east}} & {σ}_{lat} {σ}_{{acc}_{north}} & {σ}_{lat} {σ}_{{acc}_{east}} \\ {σ}_{lat} {σ}_{lon} & {σ}_{lon}^{2} & {σ}_{lon} {σ}_{{vel}_{north}} & {σ}_{lon} {σ}_{{vel}_{east}} & {σ}_{lon} {σ}_{{acc}_{north}} & {σ}_{lon} {σ}_{{acc}_{east}} \\ {σ}_{lat} {σ}_{{vel}_{north}} & {σ}_{lon} {σ}_{{vel}_{north}} & {σ}_{{vel}_{north}}^{2} & {σ}_{{vel}_{north}} {σ}_{{vel}_{east}} & {σ}_{{vel}_{north}} {σ}_{{acc}_{north}} & {σ}_{{vel}_{north}} {σ}_{{acc}_{east}} \\ {σ}_{lat} {σ}_{{vel}_{east}} & {σ}_{lon} {σ}_{{vel}_{east}} & {σ}_{{vel}_{north}} {σ}_{{vel}_{east}} & {σ}_{{vel}_{east}}^{2} & {σ}_{{vel}_{east} {σ}_{{acc}_{north}}} & {σ}_{{vel}_{east}} {σ}_{{acc}_{east}} \\ {σ}_{lat} {σ}_{{acc}_{north}} & {σ}_{lon} {σ}_{{acc}_{north}} & {σ}_{{vel}_{north}} {σ}_{{acc}_{north}} & {σ}_{{vel}_{east} {σ}_{{acc}_{north}}} & {σ}_{{acc}_{north}}^{2} & {σ}_{{acc}_{north}} {σ}_{{acc}_{east}} \\ {σ}_{lat} {σ}_{{acc}_{east}} & {σ}_{lon} {σ}_{{acc}_{east}} & {σ}_{{vel}_{north}} {σ}_{{acc}_{east}} & {σ}_{{vel}_{east}} {σ}_{{acc}_{east}} & {σ}_{{acc}_{north}} {σ}_{{acc}_{east}} & {σ}_{{acc}_{east}}^{2}\end{matrix} ]}_{k}$$

where: \hat{x}_{k,k}=filter state vector
   P_{k,k}=filter state covariance matrix
   [symbol] =filter estimated emitter latitude
   [symbol] =filter estimated emitter longitude
   [symbol] ₙₒᵣₜₕ=filter estimated emitter northing velocity
   [symbol] ₑₐₛₜ=filter estimated emitter easting velocity
   [symbol] ₙₒᵣₜₕ=filter estimated emitter northing acceleration
   [symbol] ₑₐₛₜ=filter estimated emitter easting acceleration
   σₗₐₜ=filter estimated emitter latitude uncertainty (1-sigma)
   σₗₒₙ=filter estimated emitter longitude uncertainty (1-sigma)
   σᵥₑₗ_{ₙₒᵣₜₕ}=filter estimated emitter northing velocity uncertainty (1-sigma)
   σᵥₑₗ_{ₑₐₛₜ}=filter estimated emitter easting velocity uncertainty (1-sigma)
   σ_{acc}_{ₙₒᵣₜₕ}=filter estimated emitter northing acceleration uncertainty (1-sigma)
   σ_{acc}_{ₑₐₛₜ}=filter estimated emitter easting acceleration uncertainty (1-sigma)

As can be seen from these definitions of the state vector and covariance matrix, constraining the emitter location to the surface of the Earth eliminates the need for extra state variables to represent the altitude of the emitter. The constraint also eliminates the need for additional computations that would be required to update those extra state variables. For example, the 6-state operational mode described above would transform into a 9-state mode (3 additional states for altitude position, altitude velocity, and altitude acceleration), and the covariance matrix would increase in size from 6×6 to 9×9, resulting in an exponential increase in computational cost.

For initialization in the stationary 2-state operational mode, the filter state vector and covariance matrix are initialized as follows:

$${\hat{x}}_{0 , 0} = {[ \begin{matrix} & \end{matrix} ]}_{0} \\ {P}_{0 , 0} = {[ \begin{matrix}{σ}_{lat}^{2} & 0 \\ 0 & {σ}_{lon}^{2}\end{matrix} ]}_{0}$$

where: \hat{x}_{0,0}=filter initialized state vector for 2 state operation
   P_{0,0}=filter initialized state covariance matrix for 2 state operation
   [symbol] =latitude of initial region of interest center
   [symbol] =longitude of initial region of interest center
   σₗₐₜ=latitude uncertainty of initial region of interest (1-sigma)
   σₗₒₙ=longitude uncertainty of initial region of interest (1-sigma)

For initialization in the constant velocity 4-state operational mode, the filter state vector and covariance matrix are initialized as follows:

$${\hat{x}}_{0 , 0} = {[ \begin{matrix} & & {north}_{} & {east}_{}\end{matrix} ]}_{0} \\ {P}_{0 , 0} = {[ \begin{matrix}{σ}_{lat}^{2} & 0 & 0 & 0 \\ 0 & {σ}_{lon}^{2} & 0 & 0 \\ 0 & 0 & {σ}_{{vel}_{north}}^{2} & 0 \\ 0 & 0 & 0 & {σ}_{{vel}_{east}}^{2}\end{matrix} ]}_{0}$$

where: \hat{x}_{0,0}=filter initialized state vector for 4 state operation
   P_{0,0}=filter initialized state covariance matrix for 4 state operation
   [symbol] =latitude of initial region of interest center
   [symbol] =longitude of initial region of interest center
   [symbol] ₙₒᵣₜₕ=expected initial emitter northing velocity
   [symbol] ₑₐₛₜ=expected initial emitter easting velocity
   σₗₐₜ=latitude uncertainty of initial region of interest (1-sigma)
   σₗₒₙ=longitude uncertainty of initial region of interest (1-sigma)
   σᵥₑₗ_{ₙₒᵣₜₕ}=maximum expected northing velocity (1-sigma)
   σᵥₑₗ_{ₑₐₛₜ}=maximum expected easting velocity (1-sigma)

For initialization in the planar acceleration 6-state operational mode, the filter state vector and covariance matrix are initialized as follows:

$${\hat{x}}_{k , k} = {[ \begin{matrix} & & {north}_{} & {east}_{} & {north}_{} & {east}_{}\end{matrix} ]}_{0} \\ {P}_{0 , 0} = {[ \begin{matrix}{σ}_{lat}^{2} & 0 & 0 & 0 & 0 & 0 \\ 0 & {σ}_{lon}^{2} & 0 & 0 & 0 & 0 \\ 0 & 0 & {σ}_{{vel}_{north}}^{2} & 0 & 0 & 0 \\ 0 & 0 & 0 & {σ}_{{vel}_{east}}^{2} & 0 & 0 \\ 0 & 0 & 0 & 0 & {σ}_{{acc}_{north}}^{2} & 0 \\ 0 & 0 & 0 & 0 & 0 & {σ}_{{acc}_{east}}^{2}\end{matrix} ]}_{0}$$

where: \hat{x}_{0,0}=filter initialized state vector for 4 state operation
   P_{0,0}=filter initialized state covariance matrix for 4 state operation
   [symbol] =latitude of initial region of interest center
   [symbol] =longitude of initial region of interest center
   [symbol] ₙₒᵣₜₕ=expected initial emitter northing velocity
   [symbol] ₑₐₛₜ=expected initial emitter easting velocity
   σₗₐₜ=latitude uncertainty of initial region of interest (1-sigma)
   σₗₒₙ=longitude uncertainty of initial region of interest (1-sigma)
   σᵥₑₗ_{ₙₒᵣₜₕ}=maximum expected northing velocity (1-sigma)
   σᵥₑₗ_{ₑₐₛₜ}=maximum expected easting velocity (1-sigma)
   σ_{acc}_{ₙₒᵣₜₕ}=maximum expected northing acceleration (1-sigma)
   σ_{acc}_{ₑₐₛₜ}=maximum expected easting acceleration (1-sigma)

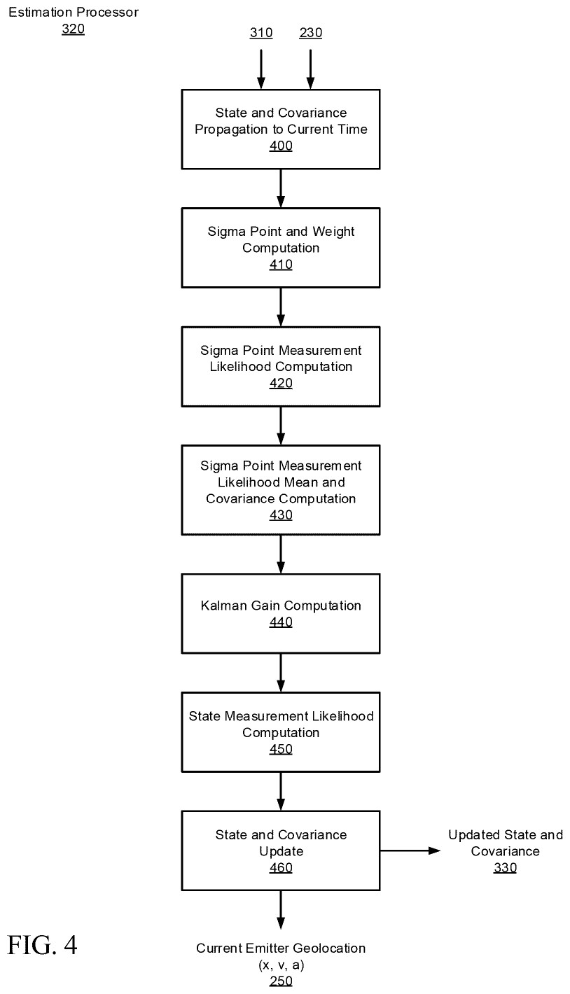

FIG. 4 is a block diagram of the estimation processor 320 of FIG. 3, configured in accordance with an embodiment of the present disclosure. The estimation processor 320 is shown to include a state and covariance propagation circuit 400, a sigma point and weight computation circuit 410, a sigma point measurement likelihood computation circuit 420, a sigma point measurement likelihood mean and covariance computation circuit 430, a Kalman gain computation circuit 440, a state measurement likelihood computation circuit 450, and a state and covariance update circuit 460.

The state and covariance propagation circuit 400 is configured to propagate the filter state vector and covariance to the time of the current measurement.

For fixed emitters (e.g., stationary emitters), no operation is required at this point. This is referred to as the 2-state case. In this case, the filter state and covariance from the previous time iteration is carried over to the current time iteration.

For emitters moving with constant velocity, the filter state vector and covariance are propagated to the time of the current measurement in a manner consistent with the expected kinematics of the emitter of interest. This is referred to as the 4-state case. The method of time propagation for constant velocity emitter motion for the k^{th} time iteration may be expressed by the following equations:

$${\hat{x}}_{k , k - 1} = Φ {\hat{x}}_{k - 1 , k - 1} \\ {P}_{k , k - 1} = Φ {P}_{k - 1 , k - 1} {Φ}^{′} + Q$$

where: \hat{x}_{k,k-1}=filter state vector (propagated to current time)
   P_{k,k-1}=filter state covariance matrix (propagated to current time)
   \hat{x}_{k-1,k-1}=filter state vector (updated or initialized at previous time)
   P_{k-1,k-1}=filter state covariance matrix (updated or initialized at previous time)
   Φ=state transition matrix
   Q=process noise matrix
with:

$$Φ = [ \begin{matrix}1 & 0 & \frac{Δ t}{( {M}_{e} + {H}_{e} )} & 0 \\ 0 & 1 & 0 & \frac{Δ t}{( {N}_{e} + {H}_{e} ) cos ( {\hat{x}}_{k , k - 1} ( 1 ) )} \\ 0 & 0 & 1 & 0 \\ 0 & 0 & 0 & 1\end{matrix} ] \\ Q = [ \begin{matrix}0 & 0 & 0 & 0 \\ 0 & 0 & 0 & 0 \\ 0 & 0 & {σ}_{vel}^{2} & 0 \\ 0 & 0 & 0 & {σ}_{vel}^{2}\end{matrix} ]$$

and: Δt=time difference from last update to current measurement
   Mₑ=earth meridian radius of curvature
   Nₑ=earth vertical radius of curvature
   Hₑ=expected terrain altitude
   σᵥₑₗ²=velocity process noise variance

For emitters moving with constant acceleration, the filter state vector and covariance are propagated to the time of the current measurement in a manner consistent with the expected kinematics of the emitter of interest. This is referred to as the 6-state case. The method of time propagation for constant acceleration emitter motion for the k^{th} time iteration may be expressed by the following equations:

$${\hat{x}}_{k , k - 1} = Φ {\hat{x}}_{k - 1 , k - 1} \\ {P}_{k , k - 1} = Φ {P}_{k - 1 , k - 1} {Φ}^{′} + Q$$

where: \hat{x}_{k,k-1}=filter state vector (propagated to current time)
   P_{k,k-1}=filter state covariance matrix (propagated to current time)
   \hat{x}_{k-1,k-1}=filter state vector (updated or initialized at previous time)
   P_{k-1,k-1}=filter state covariance matrix (updated or initialized at previous time)
   Φ=state transition matrix
   Q=process noise matrix
with:

$$Φ = [ \begin{matrix}1 & 0 & \frac{Δ t}{( {M}_{e} + {H}_{e} )} & 0 & 0 & 0 \\ 0 & 1 & 0 & \frac{Δ t}{( {N}_{e} + {H}_{e} ) cos ( {\hat{x}}_{k , k - 1} ( 1 ) )} & 0 & 0 \\ 0 & 0 & 1 & 0 & Δ t & 0 \\ 0 & 0 & 0 & 1 & 0 & Δ t \\ 0 & 0 & 0 & 0 & 1 & 0 \\ 0 & 0 & 0 & 0 & 0 & 1\end{matrix} ] \\ Q = [ \begin{matrix}0 & 0 & 0 & 0 & 0 & 0 \\ 0 & 0 & 0 & 0 & 0 & 0 \\ 0 & 0 & {σ}_{vel}^{2} & 0 & 0 & 0 \\ 0 & 0 & 0 & {σ}_{vel}^{2} & 0 & 0 \\ 0 & 0 & 0 & 0 & {σ}_{acc}^{2} & 0 \\ 0 & 0 & 0 & 0 & 0 & {σ}_{acc}^{2}\end{matrix} ]$$

and: Δt=time difference from last filter update to current measurement
   Mₑ=earth meridian radius of curvature
   Nₑ=earth vertical radius of curvature
   Hₑ=expected terrain altitude
   σᵥₑₗ²=velocity process noise variance
   σ_{acc}²=acceleration process noise variance

The sigma point and weight computation circuit 410 is configured to compute sigma points χ that are used for approximating the filter measurement-to-state non-linearities. The sigma points can be computed for the k^{th} time iteration as follows:

$$\begin{matrix}{χ}_{0 , k} = {\hat{x}}_{k , k - 1} , & {W}_{0} = \frac{κ}{{N}_{s} + κ} \\ {χ}_{i , k} = {\hat{x}}_{k , k - 1} + {( \sqrt{( {N}_{s} + κ ) {P}_{k , k - 1}} )}_{i} , & {W}_{i} = \frac{1}{2 ( {N}_{s} + κ )} \\ {χ}_{i + {N}_{s} , k} = {\hat{x}}_{k , k - 1} - {( \sqrt{( {N}_{s} + κ ) {P}_{k , k - 1}} )}_{i} , & {W}_{i + {N}_{s}} = \frac{1}{2 ( {N}_{s} + κ )}\end{matrix}$$

where: \hat{x}_{k,k-1}=filter state vector (propagated to current time)
   P_{k,k-1}=filter state covariance matrix (propagated to current time)
   χ_{i,k}=sigma point corresponding to i^{th} row of covariance scaling
   Wᵢ=sigma point weight corresponding to i^{th} sigma point
   i=sigma point and weight index (i=1, 2, . . . , Nₛ)
   κ=sigma point shaping constant
   Nₛ=number filter of states
      The sigma point shaping constant K is a tuning parameter that can be adjusted based on data characteristics of a particular application and is used to apply a nominal “spread” to the sigma points relative to the estimated state and covariance. In some embodiments, the sigma point shaping constant is set to one.

The sigma point measurement likelihood computation circuit 420 is configured to compute measurement likelihoods Z_{i,k} conditioned on the sigma points calculated above for the k^{th} time iteration using. The measurement likelihoods can be computed as follows:

$${Z}_{i , k} = H [ {χ}_{i , k} ]$$

where: Z_{i,k}=measurement likelihood conditioned on i^{th} sigma point
   χ_{i,k}=sigma points (i=0, 1, . . . , 2Nₛ)
   H=measurement likelihood function

The measurement likelihood function H is specific to the measurement modality (e.g., AOA versus TDOA). The measurement likelihood function is described below for each of these cases.

For azimuth and depression angle of arrival, the measurement likelihood function computes the azimuth and depression AOA measurement likelihood Z_{i,k} at the k^{th} time iteration conditioned on a given sigma point relative to the current platform position. The measurement likelihood function for this case can be computed as follows:

$${x}_{p , k , NED} = lla 2 Ned ( {x}_{p , k , LLA} ) \\ {χ}_{i , k , NED} = lla 2 Ned ( {χ}_{i , k} ) \\ {D}_{i , NED} = {χ}_{i , k , NED} - {x}_{p , k , NED} \\ {D}_{i , BODY} = ned 2 Body ( {D}_{i , NED} , {ψ}_{p , k} ) \\ {Z}_{i , k} = [ \begin{matrix}a tan & ( \frac{{D}_{i , BODY} ( 2 )}{{D}_{i , BODY} ( 1 )} ) & \frac{{D}_{i , BODY} ( 3 )}{‖ {D}_{i , BODY} ‖}\end{matrix} ]$$

where: x_{p,k,LLA}=platform position in WGS-84 LLA coordinate frame
   x_{p,k,NED}=platform position in local NED (North, East, Down) coordinate frame
   χ_{i,k}=i^{th} sigma point in WGS-84 LLA coordinate frame
   χ_{i,k,NED}=i^{th} sigma point in local NED coordinate frame
   D_{i,NED}=distance vector between platform position and i^{th} sigma point in local NED frame
   D_{i,BODY}=distance vector between platform position and i^{th} sigma point in Body frame
   ψ_{p,k}=platform Euler angles
   Z_{i,k}=azimuth/depression AOA measurement likelihood for i^{th} sigma point
   lla2Ned( )=WGS-84 LLA to local NED coordinate conversion function

For TDOA, the measurement likelihood function computes the time difference of arrival measurement likelihood Z_{i,k} at the k^{th} time iteration conditioned on a given sigma point relative to two platform locations. The measurement likelihood function for this case can be computed as follows:

$${x}_{p 1 , k , ECEF} = lla 2 Ecef ( {x}_{p 1 , k , LLA} ) \\ {x}_{p 2 , k , ECEF} = lla 2 Ecef ( {x}_{p 2 , k , LLA} ) \\ {χ}_{i , k , ECEF} = lla 2 Ecef ( {χ}_{i , k} ) \\ {D}_{i , p 1 , ECEF} = {χ}_{i , k , ECEF} - {x}_{p 1 , k , ECEF} \\ {D}_{i , p 2 , ECEF} = {χ}_{i , k , ECEF} - {x}_{p 2 , k , ECEF} \\ {R}_{i , p 1} = ‖ {D}_{i , p 1 , ECEF} ‖ \\ {R}_{i , p 2} = ‖ {D}_{i , p 2 , ECEF} ‖ \\ {toa}_{i , p 1} = \frac{{R}_{i , p 1}}{c} \\ {toa}_{i , p 2} = \frac{{R}_{i , p 2}}{c} \\ {Z}_{i , k} = {toa}_{i , p 1} - {toa}_{i , p 2}$$

where: x_{p1,k,LLA}=first platform position in WGS-84 LLA coordinate frame
   x_{p1,k,ECEF}=first platform position in ECEF (Earth-Centered, Earth-Fixed) coordinate frame
   x_{p2,k,LLA}=second platform position in WGS-84 LLA coordinate frame
   x_{p2,k,ECEF}=second platform position in ECEF coordinate frame
   χ_{i,k=i}^{th} sigma point in WGS-84 LLA coordinate frame
   χ_{i,k,ECEF}=i^{th} sigma point in ECEF coordinate frame
   D_{i,p1,ECEF}=distance vector between first platform position and i^{th} sigma point in ECEF frame
   D_{i,p2,ECEF}=distance vector between second platform position and i^{th} sigma point in ECEF frame
   R_{i,p1}=range from first platform position to i^{th} sigma point
   R_{i,p2}=range from second platform position to i^{th} sigma point
   toa_{i,p1}=first platform time of arrival likelihood for i^{th} sigma point
   toa_{i,p2}=second platform time of arrival likelihood for i^{th} sigma point
   c=speed of light
   Z_{i,k}=TDOA measurement likelihood for i^{th} sigma point
   lla2Ecef( )=WGS-84 LLA to local NED coordinate conversion function

The sigma point measurement likelihood mean and covariance computation circuit 430 is configured to calculate the sigma point measurement likelihood mean and covariance, \hat{z}_{k,k-1} and P_{z}_{ₖ}_{,z}_{ₖ}, at the k^{th} time iteration, using the unscented transform, as follows:

$${\hat{z}}_{k , k - 1} = {\sum }_{i = 0}^{2 {N}_{s}} {W}_{i} {Z}_{i , k} \\ {P}_{{z}_{k ,} , {z}_{k ,}} = {\sum }_{i = 0}^{2 {N}_{s}} {W}_{i} ( {Z}_{i , k} - {\hat{z}}_{k , k - 1} ) {( {Z}_{i , k} - {\hat{z}}_{k , k - 1} )}^{′}$$

where: Wᵢ=sigma point weight corresponding to i^{th} sigma point
   Z_{i,k}=measurement likelihood for i^{th} sigma point
   \hat{z}_{k,k-1}=sigma point measurement likelihood mean
   P_{z}_{ₖ}_{,z}_{ₖ}=sigma point measurement likelihood covariance
   i=sigma point measurement likelihood and weight index (i=1, 2, . . . , Nₛ)
   Nₛ=number of filter states

The Kalman gain computation circuit 440 is configured to compute the Kalman gain Kₖ for the unscented Kalman filter. The gain computation may be expressed by the following equations:

$${P}_{{x}_{k ,} , {z}_{k ,}} = {\sum }_{i = 0}^{2 {N}_{s}} {W}_{i} ( {χ}_{i , k} - {\hat{x}}_{k , k - 1} ) {( {Z}_{i , k} - {\hat{z}}_{k , k - 1} )}^{′} \\ {K}_{k} = {{P}_{{x}_{k ,} , {z}_{k ,}} ( {P}_{{z}_{k ,} , {z}_{k ,}} + {R}_{k} )}^{- 1}$$

where: Pₓ_{ₖ}_{,z}_{ₖ}=sigma point state-measurement cross covariance
   \hat{x}_{k,k-1}=filter state vector (propagated to current time)
   χ_{i,k}=sigma points (i=0, 1, . . . , 2Nₛ)
   \hat{z}_{k,k-1}=sigma point measurement likelihood mean
   Z_{i,k}=measurement likelihood for i^{th} sigma point
   Kₖ=Kalman gain matrix
   P_{z}_{ₖ}_{,z}_{ₖ}=sigma point measurement likelihood covariance
   Rₖ=measurement covariance matrix
   i=sigma point measurement likelihood and weight index (i=1, 2, . . . , Nₛ)
   Nₛ=number of filter states

The state measurement likelihood computation circuit 450 is configured to compute the state measurement likelihood conditioned on the filter state vector \hat{z}ₖ for the k^{th} time iteration. The state measurement likelihood computation may be expressed by the following equations:

$${\hat{z}}_{k} = H [ {\hat{x}}_{k , k - 1} ]$$

where: \hat{z}ₖ=measurement likelihood conditioned on \hat{x}_{k,k-1}
   \hat{x}_{k,k-1}=filter state vector (propagated to current time)
   H=state measurement likelihood function

The state measurement likelihood function H is specific to the measurement modality (e.g., AOA versus TDOA). The equations described above for calculating the AOA measurement likelihood and TDOA measurement likelihood may be used again here to calculate the AOA state measurement likelihood and TDOA state measurement likelihood with one difference: substituting the filter state vector \hat{x}_{k,k-1} for the sigma points χ_{i,k}.

The state and covariance update circuit 460 is configured to update the filter state \hat{x}_{k,k} and covariance matrix P_{k,k} using the updated unscented Kalman gains. The computations may be expressed by the following equations:

$${\hat{x}}_{k , k} = {\hat{x}}_{k , k - 1} + {K}_{k} ( {z}_{k} - {\hat{z}}_{k} ) \\ {P}_{k , k} = {P}_{k , k - 1} - {K}_{k} {P}_{{z}_{k ,} , {z}_{k ,}} {K}_{k}^{′}$$

where: \hat{x}_{k,k}=filter state vector (updated at current time)
   P_{k,k}=filter state covariance matrix (updated at current time)
   \hat{x}_{k,k-1}=filter state vector (propagated to current time)
   P_{k,k-1}=filter state covariance matrix (propagated to current time)
   Kₖ=Kalman gain matrix
   zₖ=filter measurement vector
   \hat{z}ₖ=measurement likelihood conditioned on \hat{x}_{k,k-1}
   P_{z}_{ₖ}_{,z}_{ₖ}=sigma point measurement likelihood covariance

### Methodology

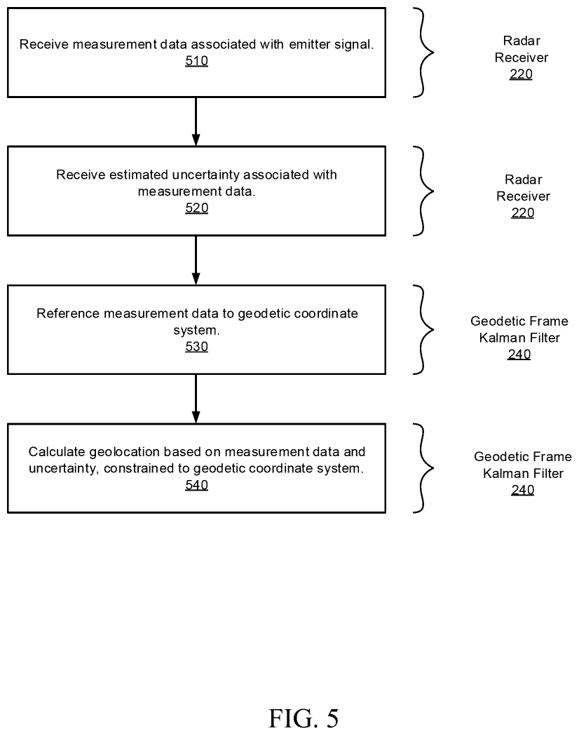

FIG. 5 is a flowchart illustrating a methodology 500 for emitter geolocation and tracking using the geodetic frame Kalman filter 240 of FIG. 2, in accordance with an embodiment of the present disclosure. As can be seen, example method 500 includes a number of phases and sub-processes, the sequence of which may vary from one embodiment to another. However, when considered in the aggregate, these phases and sub-processes form a process for off-axis projectile guidance, in accordance with certain of the embodiments disclosed herein. These embodiments can be implemented, for example using the system architecture illustrated in FIGS. 2-4, as described above. However other system architectures can be used in other embodiments, as will be apparent in light of this disclosure. To this end, the correlation of the various functions shown in FIG. 5 to the specific components illustrated in FIGS. 2-4, is not intended to imply any structural and/or use limitations. Rather other embodiments may include, for example, varying degrees of integration wherein multiple functionalities are effectively performed by one system. Numerous variations and alternative configurations will be apparent in light of this disclosure.

As illustrated in FIG. 5, in one embodiment method 500 commences, at operation 510, by receiving measurement data associated with a signal from a target emitter. In some embodiments, the measurement data comprises azimuth angle of arrival of the signal and depression angle of arrival of the signal. In some embodiments, the measurement data comprises a time difference of arrival of the signal between two measurement platforms. The two platforms may be two airborne platforms or two antennas on the same airborne platform.

Next, at operation 520, an estimated uncertainty associated with the measurement data is received. In some embodiments, a measurement covariance matrix is populated by provided one sigma measurement uncertainties. In some embodiments, the measurement data and measurement data estimated uncertainty are provided by a radar receiver.

In some embodiments, at operation 530, the measurement data is referenced to a geodetic coordinate system. In some embodiments, the geodetic coordinate system is a WGS-84 coordinate system.

At operation 540, a Kalman filter is employed to calculate a geolocation of the emitter, based on the measurement data and the estimated uncertainty. The calculation includes constraining the geolocation of the emitter to the surface of the Earth. In some embodiments, the Kalman filter is an Unscented Kalman Filter, an Iterated Sigma Point Kalman Filter, or an Extended Kalman filter.

Of course, in some embodiments, additional operations may be performed, as previously described in connection with the system. These additional operations may include, for example, using digital terrain data to augment the process of constraining the geolocation of the emitter to the surface of the Earth.

In some embodiments, the emitter is constrained to a fixed location and the Kalman filter is a two state filter, or the emitter is constrained to a fixed velocity and the Kalman filter is a four state filter, or the emitter is constrained to a fixed acceleration and the Kalman filter is a six state filter.

### Example Platforms

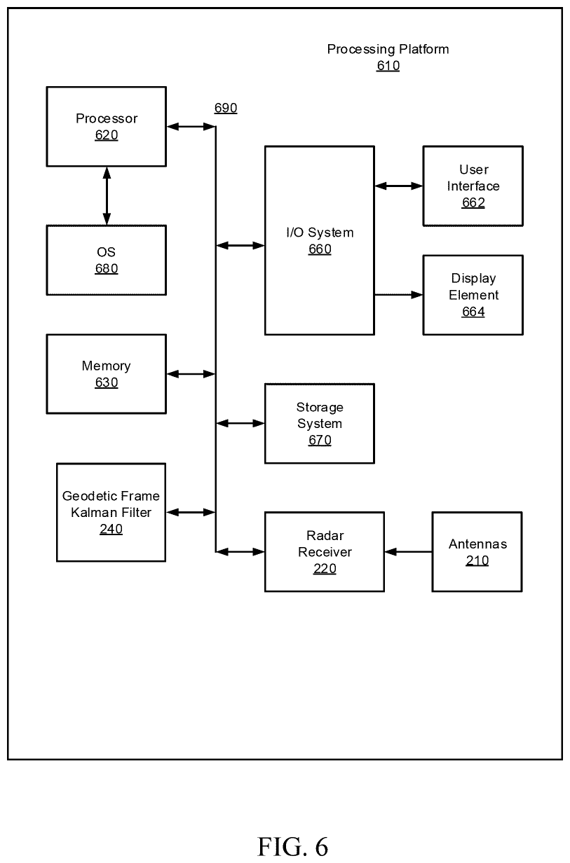

FIG. 6 is a block diagram schematically illustrating a processing platform 610 employing an emitter tracking system, in accordance with certain embodiments of the present disclosure. In some embodiments, processing platform 610, or portions thereof, may be hosted on, or otherwise be incorporated into an aircraft, a projectile, a missile, or any other suitable airborne platform or the electronic systems of an airborne platform.

In some embodiments, processing platform 610 may comprise any combination of a processor 620, a memory 630, an input/output (I/O) system 660, a user interface 662, a display element 664, a storage system 670, geodetic frame Kalman filter 240, radar receiver 220, and antennas 210. As can be further seen, a bus and/or interconnect 690 is also provided to allow for communication between the various components listed above and/or other components not shown. Other componentry and functionality not reflected in the block diagram of FIG. 6 will be apparent in light of this disclosure, and it will be appreciated that other embodiments are not limited to any particular hardware configuration.

Processor 620 can be any suitable processor, and may include one or more coprocessors or controllers, such as an audio processor, a graphics processing unit, or hardware accelerator, to assist in control and processing operations associated with platform 610. In some embodiments, the processor 620 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 620 may be implemented as a complex instruction set computer (CISC) or a reduced instruction set computer (RISC) processor.

Memory 630 can be implemented using any suitable type of digital storage including, for example, flash memory and/or random access memory (RAM). In some embodiments, the memory 630 may include various layers of memory hierarchy and/or memory caches as are known to those of skill in the art. Memory 630 may be implemented as a volatile memory device such as, but not limited to, a RAM, dynamic RAM (DRAM), or static RAM (SRAM) device. Storage system 670 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

Processor 620 may be configured to execute an Operating System (OS) 680 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with platform 610, and therefore may also be implemented using any suitable existing or subsequently-developed platform.

I/O system 660 may be configured to interface between various I/O devices and other components of platform 610. I/O devices may include, but not be limited to, user interface 662 and display element 664, which may be utilized for displaying tracking results, or configuring and testing of the system, for example. User interface 662 may include other devices (not shown) such as a touchpad, keyboard, mouse, microphone and speaker, trackball or scratch pad, and camera. I/O system 660 may include a graphics subsystem configured to perform processing of images for rendering on the display element 664. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 620 or any chipset of platform 610.

It will be appreciated that in some embodiments, some of the various components of platform 610 may be combined or integrated in a system-on-a-chip (SoC) architecture. In some embodiments, the components may be hardware components, firmware components, software components or any suitable combination of hardware, firmware or software.

Geodetic frame Kalman filter 240 is configured to calculate a geolocation of the emitter, based on measurement data and the estimated uncertainty, as previously described. In some embodiments, the measurement data and the estimated uncertainty are provided by radar receiver 220 based on emitter signals received through antennas 210. The Kalman filter 240 operates in a geodetic coordinate system and achieves improved efficiency by constraining the geolocation of the emitter to the surface of the Earth.

Various embodiments of platform 610 may be implemented using hardware elements, software elements, or a combination of both. Examples of hardware elements may include processors, microprocessors, circuits, circuit elements (for example, transistors, resistors, capacitors, inductors, and so forth), integrated circuits, application-specific integrated circuits (ASICs, or other purpose-built semiconductors), programmable logic devices, digital signal processors, field programmable gate arrays (FPGAs), logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, causes one or more of the methodologies disclosed herein to be implemented. Other componentry and functionality not reflected in the illustrations will be apparent in light of this disclosure, and it will be appreciated that other embodiments are not limited to any particular hardware or software configuration. Thus, in other embodiments platform 610 may comprise additional, fewer, or alternative subcomponents as compared to those included in the example embodiment of FIG. 6.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The aforementioned non-transitory computer readable medium may be any suitable medium for storing digital information, such as a hard drive, a server, a flash memory, and/or random access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). In some embodiments, the hardware may be modeled or developed using hardware description languages such as, for example Verilog or VHDL. Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, are functional structures that include hardware, or a combination of hardware and software, and may comprise, for example, singly or in any combination, hardwired circuitry, programmable circuitry such as computer processors comprising one or more individual instruction processing cores, state machine circuitry, and/or gate level logic. The circuitry may include a processor and/or controller programmed or otherwise configured to execute one or more instructions to perform one or more operations described herein. The instructions may be embodied as, for example, an application, software, firmware, or one or more embedded routines configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads or parallel processes in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), computers, and other processor-based or functional systems. Other embodiments may be implemented as software executed by a programmable device. In any such hardware cases that include executable software, the terms “circuit” or “circuitry” are intended to include a combination of software and hardware such as a programmable device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

One example embodiment of the present disclosure provides a tracking system comprising: a measurement system configured to provide measurement data associated with a signal from an emitter and to provide an estimated uncertainty associated with the measurement data; and a Kalman filter configured to calculate a geolocation of the emitter, based on the measurement data and the estimated uncertainty, wherein the calculation includes constraining the geolocation of the emitter to the surface of the Earth in a geodetic coordinate system.

In some cases, the measurement data comprises azimuth angle of arrival of the signal and depression angle of arrival of the signal. In some cases, the measurement data comprises a time difference of arrival of the signal between two measurement platforms. In some cases, the emitter is constrained to a fixed location and the Kalman filter is a two state filter. In some cases, the emitter is constrained to a fixed velocity and the Kalman filter is a four state filter. In some cases, the emitter is constrained to a fixed acceleration and the Kalman filter is a six state filter. In some cases, the Kalman filter is one of an Unscented Kalman Filter, an Iterated Sigma Point Kalman Filter, or an Extended Kalman Filter. In some cases, the measurement system is a radar receiver.

Another example embodiment of the present disclosure provides a computer program product including one or more machine-readable mediums encoded with instructions that when executed by one or more processors cause a process to be carried out for emitter tracking, the process comprising: receiving measurement data associated with a signal from an emitter; receiving an estimated uncertainty associated with the measurement data; and employing a Kalman filter to calculate a geolocation of the emitter, based on the measurement data and the estimated uncertainty, wherein the calculation includes constraining the geolocation of the emitter to the surface of the Earth in a geodetic coordinate system.

In some cases, the measurement data comprises azimuth angle of arrival of the signal and depression angle of arrival of the signal. In some cases, the measurement data comprises a time difference of arrival of the signal between two measurement platforms. In some cases, the emitter is constrained to a fixed location and the Kalman filter is a two state filter. In some cases, the emitter is constrained to a fixed velocity and the Kalman filter is a four state filter. In some cases, the emitter is constrained to a fixed acceleration and the Kalman filter is a six state filter. In some cases, the Kalman filter is one of an Unscented Kalman Filter, an Iterated Sigma Point Kalman Filter, or an Extended Kalman Filter.

Another example embodiment of the present disclosure provides a method for emitter tracking, the method comprising: receiving, by a processor-based system, measurement data associated with a signal from an emitter; receiving, by the processor-based system, an estimated uncertainty associated with the measurement data; and employing, by the processor-based system, a Kalman filter to calculate a geolocation of the emitter, based on the measurement data and the estimated uncertainty, wherein the calculation includes constraining the geolocation of the emitter to the surface of the Earth in a geodetic coordinate system.

In some cases, the measurement data comprises azimuth angle of arrival of the signal and depression angle of arrival of the signal. In some cases, the measurement data comprises a time difference of arrival of the signal between two measurement platforms. In some cases, the emitter is constrained to a fixed location and the Kalman filter is a two state filter. In some cases, the emitter is constrained to a fixed velocity and the Kalman filter is a four state filter. In some cases, the emitter is constrained to a fixed acceleration and the Kalman filter is a six state filter. In some cases, the Kalman filter is one of an Unscented Kalman Filter, an Iterated Sigma Point Kalman Filter, or an Extended Kalman Filter.

Another example embodiment of the present disclosure provides an aircraft comprising the tracking system of any of the examples described above, or the computer program product of any of the examples described above.

Another example embodiment of the present disclosure provides a projectile comprising the tracking system of any of the examples described above, or the computer program product of any of the examples described above.

Another example embodiment of the present disclosure provides a missile comprising the tracking system of any of the examples described above, or the computer program product of any of the examples described above.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A tracking system comprising:
a measurement system configured to provide measurement data associated with a signal from an emitter and to provide an estimated uncertainty associated with the measurement data; and
a Kalman filter configured to calculate a geolocation of the emitter, based on the measurement data and the estimated uncertainty, wherein the calculation includes constraining the geolocation of the emitter to the surface of the Earth in a geodetic coordinate system.

2. The tracking system of claim 1, wherein the measurement data comprises azimuth angle of arrival of the signal and depression angle of arrival of the signal.

3. The tracking system of claim 1, wherein the measurement data comprises a time difference of arrival of the signal between two measurement platforms.

4. The tracking system of claim 1, wherein the emitter is constrained to a fixed location and the Kalman filter is a two state filter.

5. The tracking system of claim 1, wherein the emitter is constrained to a fixed velocity and the Kalman filter is a four state filter.

6. The tracking system of claim 1, wherein the emitter is constrained to a fixed acceleration and the Kalman filter is a six state filter.

7. The tracking system of claim 1, wherein the Kalman filter is one of an Unscented Kalman Filter, an Iterated Sigma Point Kalman Filter, or an Extended Kalman Filter.

8. The tracking system of claim 1, wherein the measurement system is a radar receiver.

9. A computer program product including one or more machine-readable mediums encoded with instructions that when executed by one or more processors cause a process to be carried out for emitter tracking, the process comprising:
receiving measurement data associated with a signal from an emitter;
receiving an estimated uncertainty associated with the measurement data; and
employing a Kalman filter to calculate a geolocation of the emitter, based on the measurement data and the estimated uncertainty, wherein the calculation includes constraining the geolocation of the emitter to the surface of the Earth in a geodetic coordinate system.

10. The computer program product of claim 9, wherein the measurement data comprises azimuth angle of arrival of the signal and depression angle of arrival of the signal.

11. The computer program product of claim 9, wherein the measurement data comprises a time difference of arrival of the signal between two measurement platforms.

12. The computer program product of claim 9, wherein the emitter is constrained to a fixed location and the Kalman filter is a two state filter.

13. The computer program product of claim 9, wherein the emitter is constrained to a fixed velocity and the Kalman filter is a four state filter.

14. The computer program product of claim 9, wherein the emitter is constrained to a fixed acceleration and the Kalman filter is a six state filter.

15. The computer program product of claim 9, wherein the Kalman filter is one of an Unscented Kalman Filter, an Iterated Sigma Point Kalman Filter, or an Extended Kalman Filter.

16. A method for emitter tracking, the method comprising:
receiving, by a processor-based system, measurement data associated with a signal from an emitter;
receiving, by the processor-based system, an estimated uncertainty associated with the measurement data; and
employing, by the processor-based system, a Kalman filter to calculate a geolocation of the emitter, based on the measurement data and the estimated uncertainty, wherein the calculation includes constraining the geolocation of the emitter to the surface of the Earth in a geodetic coordinate system.

17. The method of claim 16, wherein the measurement data comprises azimuth angle of arrival of the signal and depression angle of arrival of the signal.

18. The method of claim 16, wherein the measurement data comprises a time difference of arrival of the signal between two measurement platforms.

19. The method of claim 16, wherein the emitter is constrained to a fixed location and the Kalman filter is a two state filter.

20. The method of claim 16, wherein the emitter is constrained to a fixed velocity and the Kalman filter is a four state filter.

21. The method of claim 16, wherein the emitter is constrained to a fixed acceleration and the Kalman filter is a six state filter.

22. The method of claim 16, wherein the Kalman filter is one of an Unscented Kalman Filter, an Iterated Sigma Point Kalman Filter, or an Extended Kalman Filter.
